(19) United States
(12) Patent Application Publication
(10) Pub. No.: US 2015/0280990 A1
(43) Pub. Date: Oct. 1, 2015

(54) OUTDOOR DEVICE MANAGEMENT SYSTEM

(71) Applicant: GENERAL LUMINAIRE CO., LTD., Taipei City (TW)

(72) Inventors: YUNG-HONG WANG, TAIPEI CITY (TW); JUN-FENG LUO, SHANGHAI CITY (CN)

(73) Assignee: GENERAL LUMINAIRE CO., LTD., Taipei City (TW)

(21) Appl. No.: 14/228,276

(22) Filed: Mar. 28, 2014

(51) Int. Cl. H04L 12/24; H04L 12/26; H04B 5/00

(52) U.S. Cl. CPC H04L 41/0853; H04B 5/0025; H04L 43/04

(57) ABSTRACT

Disclosed is an outdoor device management system, and a recognition device having a blank record is installed in the outdoor device and includes a first transmission module for electrically connecting a second transmission module of an electronic device such as a mobile phone or a tablet PC. When the outdoor device is installed, an identification code of the electronic device is set and provided to the outdoor device, while coordinates of the outdoor device are captured to form installation data containing the identification code, and the installation data are transmitted to the terminal device, so that the terminal device labels the outdoor device at a corresponding location of a map to complete the installation operation, and the electronic device transmits the identification code or installation data to the recognition device through the second transmission module and the first transmission module for storage and record.

### BACKGROUND OF THE INVENTION

1. Field of the Invention

The present invention relates to the field of outdoor device management systems, and more particularly to an outdoor device management system with low configuration cost and an identification code of an outdoor device may be set up anytime instead of being set up in the production process, so as to achieve the effects of reducing the level of complexity and lowering the configuration cost of the entire system.

2. Description of the Related Art

As science and technology advance, various types of public facilities such as road lamps, street trash cans, electrical boxes, monitors, cameras, traffic lights, electrical towers, electric meters, sprinklers, switch boxes and other outdoor devices are developed to provide us a safe, comfortable and convenient life, and the development, management, and maintenance of the outdoor devices are important factors to provide good service and improve our life quality. In addition to the repair and maintenance for abnormal situations, the management of public facilities also needs to check the equipment operation condition and maintenance periodically to assure the quality of operation, and thus the aforementioned management operation undoubtedly requires lots of manpower and cost, and the manual inspection of facilities in different areas has a lower operation efficiency and thus affecting the management quality.

To support the aforementioned objective of promoting the social development, a road lamp device with wireless communication mechanism as disclosed in R.O.C. Patent No. M416928 is provided, wherein a built-in environmental measurement unit is provided for monitoring the brightness and automatically adjusting the time of turning on the lamp and the brightness of the lamp, and the device is also capable of noticing a management service about an abnormal situation, so that a manager can go to the site to maintain and repair the road lamp, and the device also serves as a wireless communication base station to facilitate the installation of hotspots of Internet. Further, an outdoor telecommunication box monitoring device is disclosed in R.O.C. Pat. No. M424561, and the management is enhanced by the recognition of an electronic box door and the record of use by personnel, so as to prevent unauthorized persons from tapping the phone line, and the system monitoring is enhanced by collecting the status of the box. The aforementioned prior arts provide the detection record of environmental parameters, error report, terminal instruction issuance, or a combination of the above in hope of improving the management efficiency and quality. Thus, it is necessary to burn and set up an identification code for each outdoor device during the manufacturing process of the device before the terminal management equipment can recognize each outdoor device in the system installation stage, otherwise a manager is unable to know about the equipment at issue easily even if the manager receives an abnormality report, and the installation of the electronic management system becomes useless. However, the process of burning and setting up the aforementioned identification code is a customized process, not only increasing the level of complexity of the overall manufacturing process, but also incurring additional manufacturing processes to maintain, repair or replace the outdoor device whenever there is a bad or damaged outdoor device, and finally resulting an increased management cost of the entire system. Obviously, such outdoor devices are not conducive to economic benefit and industrial development.

In view of the aforementioned problems, it is a main subject for related manufacturers to improve the configuration procedure of the identification code, simplify the customized process, and lower the production cost, so as to avoid high rework rate, inventory rate or scrap rate even if the installation plan of the outdoor device is changed at a later stage, and also lower the overall system management cost to improve the economic efficiency.

### SUMMARY OF THE INVENTION

Therefore, it is a primary objective of the present invention to provide an outdoor device management system with low configuration cost, wherein a recognition device with blank record is built in an outdoor device, and an identification code of a wireless electronic device is recorded into the recognition device at a later installation procedure to unify the equipment production process and equipment production specification, so as to achieve the effects of lowering the total production cost and the total system cost.

To achieve the aforementioned objective, the present invention provides an outdoor device management system with low configuration cost comprising a terminal device, an electronic device and a recognition device, and after the electronic device has a Global Positioning System (GPS) chip, and the recognition device is installed in an outdoor device such as a road lamp, a traffic light, an electrical box, a monitor, an electric meter or a sprinkler, the electronic device is electrically connected to the terminal device to complete the installation configuration of the outdoor device, characterized in that the recognition device has a first transmission module, and the electronic device has a second transmission module for electrically connecting the first transmission module. When the outdoor device is installed, the electronic device sets an identification code to the outdoor device, while capturing coordinates of the outdoor device to generate installation data containing the identification code and transmitting the installation data to the terminal device, so that the terminal device labels a corresponding location of the outdoor device in a map according to the installation data, and the electronic device transmits the identification code or the installation data to the recognition device through the second transmission module and the first transmission module for storage and record.

Wherein, the first transmission module and the second transmission module are a near field communication (NFC) module and a photoelectric transmission module respectively. The first transmission module includes a first antenna and a first NFC transceiver electrically coupled to the first antenna, and the second transmission module includes a second antenna and a second NFC transceiver electrically coupled to the second antenna and the GPS chip, so that the first NFC transceiver and the second NFC transceiver are electrically connected through the first antenna and the second antenna for transmitting the identification code or the installation data in a radio frequency signal format. Alternately, the first transmission module includes a first light sensor and a first light transceiver electrically coupled to the first light sensor, and the second transmission module includes a second light sensor and a second light transceiver electrically coupled to the second light sensor and the GPS chip, so that the first light transceiver and the second light transceiver are electrically connected through the first light sensor and the second light sensor for transmitting the identification code or the installation data in a photoelectric signal format, and the outdoor device includes a power conversion module, a control module and a storage module, and the control module is electrically coupled to the power conversion module, the first transmission module and the storage module, and after the first NFC transceiver or the first light transceiver receives the identification code or the installation data, the identification code or the installation data is stored in the storage module and provided for the control module to read in the future.

To meet the actual requirement of a remote control, the outdoor device includes a detection module and a network module, and the network module is connected to the terminal device via a wireless network telecommunication, and the control module is electrically coupled to the detection module and the network module. The control module detects the current status of the outdoor device by the detection module to generate a detection signal containing the identification code or the installation data, and the detection signal is transmitted to the terminal device the network module and provided for the terminal device to record and analyze the detection signal, so as to monitor the outdoor device. When the terminal device analyzed and obtained an abnormality of the detection signal, the map is used for planning the best path to expedite going to the site of the outdoor device to maintain the outdoor device.

In summation, an identification code of each outdoor device is set by a handheld electronic device at the installation site of the outdoor device, so that the outdoor devices can be customized and configured at anytime instead of being set in the production process, so as to lower the production cost and facilitate manufacturers to dispatching the equipments, so as to reduce the inventory rate, rework rate and scrap rate and promote the industrial and economic development. In addition, the present invention provides an outdoor device management system integrated with map information for monitoring and analyzing data of the current status to maintain equipments of low efficiency to reduce the occurrence of abnormality. Once the abnormality of a detection signal is detected, the best path is planned to facilitate the manager to go to the site and solve the problem immediately, so as to achieve the effect of lowering the management cost.

### BRIEF DESCRIPTION OF THE DRAWINGS

FIG. 1 is a block diagram of a first implementation mode of a preferred embodiment of the present invention;

FIG. 2 is a first schematic view of the installation of the first implementation mode of a preferred embodiment of the present invention;

FIG. 3 is a second schematic view of the installation of the first implementation mode of a preferred embodiment of the present invention;

FIG. 4 is a block diagram of a second implementation mode of a preferred embodiment of the present invention; and

FIG. 5 is a schematic view of an application of the second implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

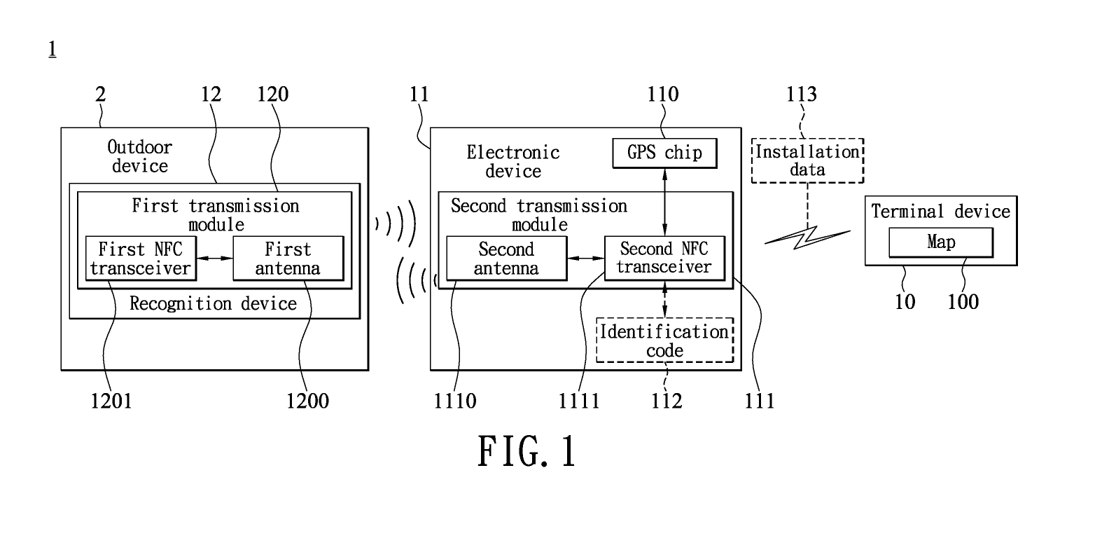

With reference to FIG. 1 for the block diagram of the first implementation mode of a preferred embodiment of the present invention, the outdoor device management system 1 with a low configuration cost is applicable for monitoring at least one outdoor device 2 such as a road lamp, a traffic light, a street trash can, an electrical box, a monitor, a camera, an electrical tower, an electric meter, a sprinkler or a switch box to achieve the effect of a convenient and accurate control, and the system 1 comprises a terminal device 10, a wireless electronic device 11 and a recognition device 12. The recognition device 12 is installed in the outdoor device 2, and the recognition device 12 includes a built-in first transmission module 120 which is an NFC module. The electronic device 11 including a GPS chip 110 is a handheld device with a positioning function such as a Smartphone, a tablet PC, a notebook or a personal digital assistant (PDA), and the electronic device 11 is connected to the terminal device 10 via a wireless network telecommunication, and the electronic device 12 includes a second transmission module 111 which is also an NFC module. In addition, the first transmission module 120 includes a first antenna 1200 and a first NFC transceiver 1201, and the second transmission module 111 includes a second antenna 1110 and a second NFC transceiver 1111, and the first NFC transceiver 1201 is electrically coupled to the first antenna 1200, and the second NFC transceiver 1111 is electrically coupled to the second antenna 1110 and the GPS chip 110, so that after the first NFC transceiver 1201 and the second NFC transceiver 1111 are electrically connected through the first antenna 1200 and the second antenna 1110, the outdoor device 2 can transmit configuration data to the terminal device 10 through the electronic device 11 to complete the installation process.

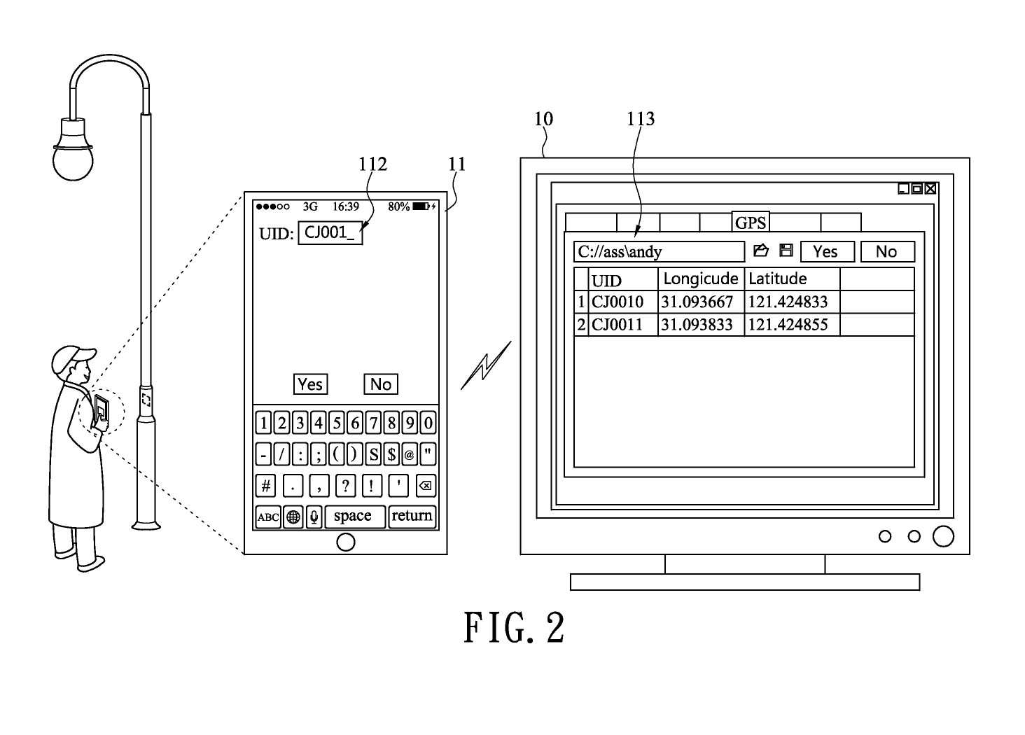

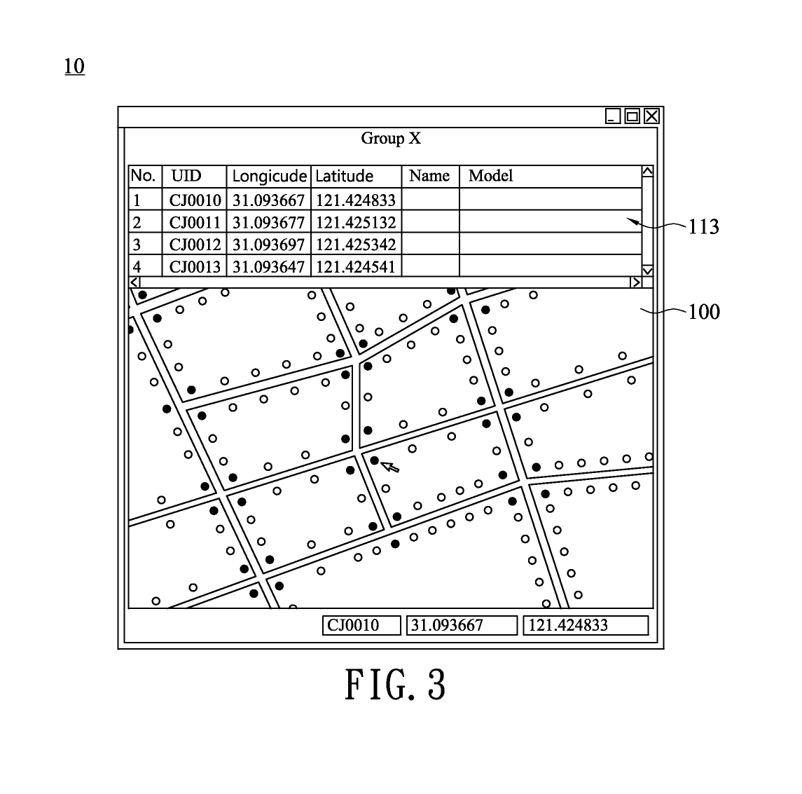

When the outdoor device 2 is installed as shown in FIGS. 2 and 3, a manager can use the electronic device 11 to set an identification code (UID) 112 to the outdoor device 2, while the electronic device 11 captures coordinates (including the latitude and longitude) of the outdoor device 2 by the GPS chip 110 to generate installation data 113 including the identification code 112, and the installation data 113 are transmitted to the terminal device 10, so that the terminal device 10 can label a corresponding location of the outdoor device 2 in a map 100 according to the coordinates of the installation data 113, and the electronic device 11 transmits the identification code 112 or the installation data 113 in a radio frequency signal format to the recognition device 12 through the second transmission module 111 and the first transmission module 120 for storage and record. It is noteworthy that the manager may further set data including a name, a model, a production date, a number of served years, a manufacturer code, or a serial number of the outdoor device 2 or any combination of the above through the electronic device 11 or the terminal device 10 to facilitate the manager to control the situations.

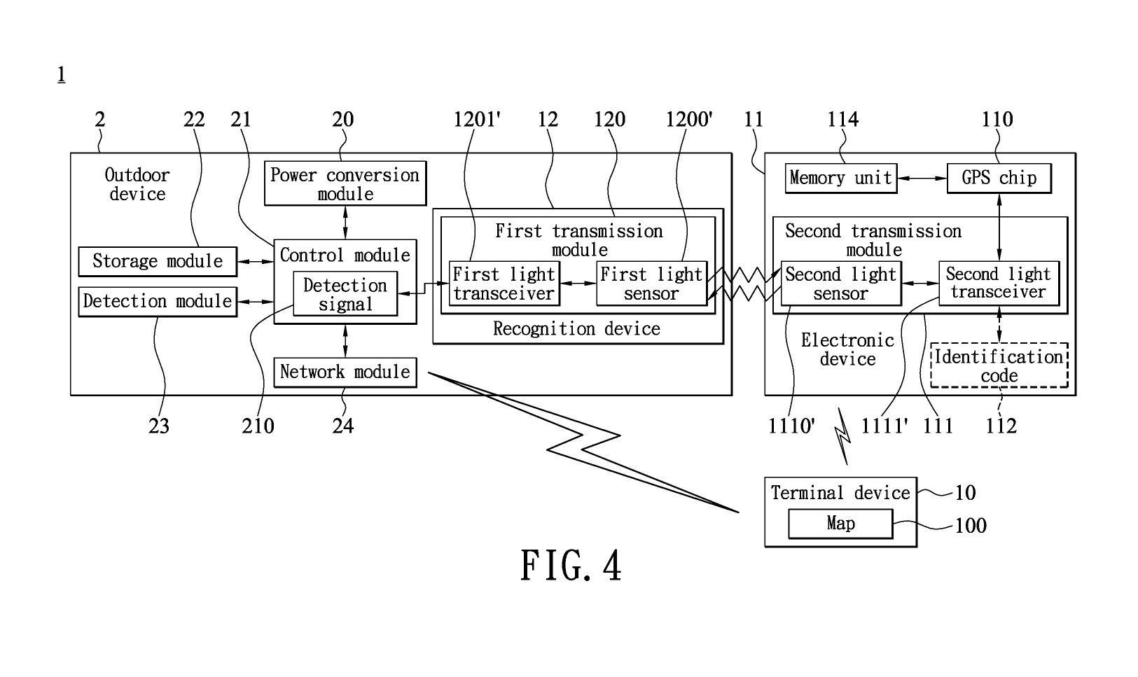

In this preferred embodiment, the first transmission module 120 and the second transmission module 111 as shown in FIG. 4 are photoelectric transmission modules. In other words, the first transmission module 120 includes a first light sensor 1200′ and a first light transceiver 1201′, and the second transmission module 111 includes a second light sensor 1110′ and a second light transceiver 1111′, and the first light transceiver 1201′ is electrically coupled to the first light sensor 1200′, and the second light transceiver 1111′ is electrically coupled to the second light sensor 1110′ and the GPS chip 110, so that the first light transceiver 1201′ and the second light transceiver 1111′ are electrically connected through the first light sensor 1200′ and the second light sensor 1110′ for transmitting the identification code 112 or the installation data 113 in a photoelectric signal format.

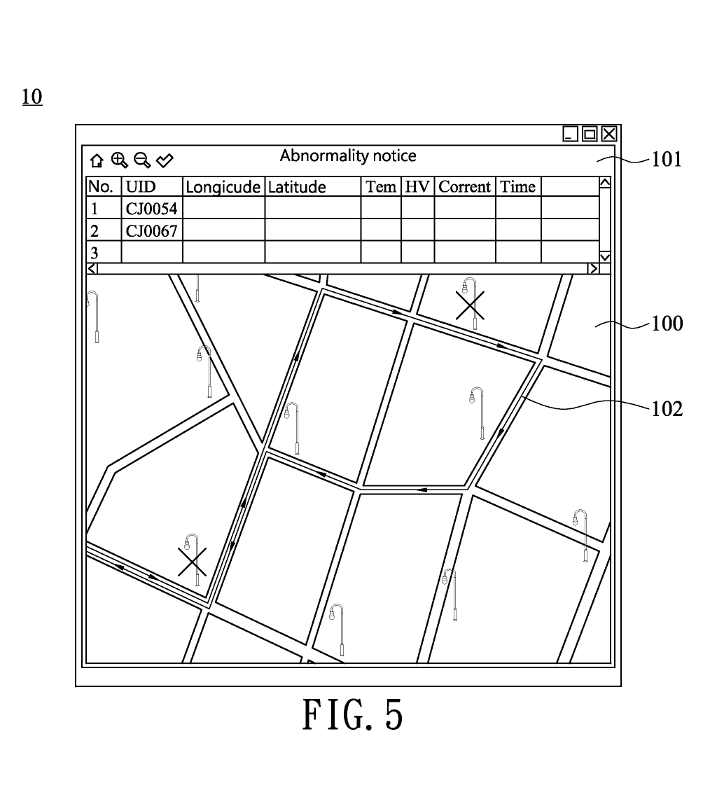

The outdoor device 2 includes a power conversion module 20, a control module 21, a storage module 22, a detection module 23 and a network module 24, and the control module 21 is electrically coupled to the power conversion module 20, the first transmission module 120, the storage module 22, the detection module 23 and the network module 24. The power conversion module 20 supplies operating kinetic energy to the built-in electronic component module of the outdoor device 2, and the network module 24 is connected to the terminal device 10 via a wireless network telecommunication, and after the first light transceiver 1201′ receives the identification code 112 or the installation data 113 through the first light sensor 1200′, the control module 21 stores the identification code 112 or the installation data 113 to the storage module 22, and the identification code 112 or the installation data 113 is provided for the control module 21 to read in the future. In addition, after the control module 21 detects the current status of the outdoor device 2 such as temperature (Tem), current, voltage value (HV), working time (Time) and full storage rate by the detection module 23 to generate a detection signal 210 containing the identification code 112 or the installation data 113, the network module 24 transmits the detection signal 210 to the terminal device 10 and provides the detection signal 210 to the terminal device 10 for recording and analysis to control the outdoor device. When the terminal device 10 has analyzed and obtained an abnormality of the detection signal 210, an abnormality notice 101 is transmitted to inform the manager as shown in FIG. 5, and the map 100 is used to automatically plan the best path 102 to expedite the processes of going to the site of the outdoor device 10 and maintaining the outdoor device 10. In addition, the recognition device 12 may be embedded into the control module 21 or installed independently, and the electronic device 11 may include a memory unit 114 electrically coupled to the GPS chip 110.

What is claimed is:

1. An outdoor device management system, comprising a terminal device, an electronic device and a recognition device, and the electronic device having a global positioning system (GPS) chip, the recognition device being provided in an outdoor device such as a street light, a traffic light, an electrical box, a monitor, an electric meter or a sprinkler, an installation configuration of the outdoor device being completed by an electrically communication between the electronic device and the terminal device, characterized in that the recognition device has a first transmission module, and the electronic device has a second transmission module for electrically connecting the first transmission module, and when the outdoor device is installed, the electronic device sets up an identification code to the outdoor device, while capturing coordinates of the outdoor device to form installation data containing the identification code and transmits the installation data to the terminal device, so that the terminal device labels the outdoor device at a corresponding location of a map according to the installation data, and the electronic device transmits the identification code or the installation data to the recognition device through the second transmission module and the first transmission module for storage.

2. The outdoor device management system according to claim 1, wherein the electronic device is a Smartphone, a tablet PC, a notebook or a personal digital assistant (PDA) with a positioning function.

3. The outdoor device management system according to claim 2, wherein the first transmission module and the second transmission module are NFC module or photoelectric transmission module respectively.

4. The outdoor device management system according to claim 3, wherein the first transmission module includes a first antenna and a first NFC transceiver electrically coupled to the first antenna, and the second transmission module includes a second antenna and a second NFC transceiver electrically coupled to the second antenna and the GPS chip, so that the first NFC transceiver and the second NFC transceiver are electrically coupled through the first antenna and the second antenna for transmitting the identification code or the installation data radio in a frequency signal format.

5. The outdoor device management system according to claim 3, wherein the first transmission module includes a first light sensor and a first light transceiver electrically coupled to the first light sensor, and the second transmission module includes a second light sensor and a second light transceiver electrically coupled to the second light sensor and the GPS chip, so that the first light transceiver and the second light transceiver are electrically coupled through the first light sensor and the second light sensor for transmitting the identification code or the installation data in a photoelectric signal format.

6. The outdoor device management system according to claim 4, wherein the outdoor device includes a power conversion module, a control module and a storage module, the control module electrically coupled to the power conversion module, the first transmission module and the storage module, and after the first NFC transceiver or the first light transceiver receives the identification code or the installation data, the identification code or the installation data is stored in the storage module for the control module to read in the future.

7. The outdoor device management system according to claim 6, wherein the outdoor device includes a detection module and a network module, and the network module is connected to the terminal device via the wireless network telecommunication, and the control module is electrically coupled to the detection module and the network module, and the control module detects the current status of the outdoor device by the detection module to generate a detection signal containing the identification code or the installation data, and transmits the detection signal to the terminal device through the network module for the terminal device to record and analyze the detection signal in order to monitor the outdoor device.

8. The outdoor device management system according to claim 7, wherein the map is used for planning a best path when the terminal device has analyzed and determined an abnormality of the detection signal, so as to expedite the action of going the site of the outdoor device to maintain the outdoor device.

9. The outdoor device management system according to claim 5, wherein the outdoor device includes a power conversion module, a control module and a storage module, the control module electrically coupled to the power conversion module, the first transmission module and the storage module, and after the first NFC transceiver or the first light transceiver receives the identification code or the installation data, the identification code or the installation data is stored in the storage module for the control module to read in the future.

10. The outdoor device management system according to claim 9, wherein the outdoor device includes a detection module and a network module, and the network module is connected to the terminal device via the wireless network telecommunication, and the control module is electrically coupled to the detection module and the network module, and the control module detects the current status of the outdoor device by the detection module to generate a detection signal containing the identification code or the installation data, and transmits the detection signal to the terminal device through the network module for the terminal device to record and analyze the detection signal in order to monitor the outdoor device.

11. The outdoor device management system according to claim 10, wherein the map is used for planning a best path when the terminal device has analyzed and determined an abnormality of the detection signal, so as to expedite the action of going the site of the outdoor device to maintain the outdoor device.
